(19) United States
(12) Patent Application Publication
(10) Pub. No.: US 2026/0175368 A1
(43) Pub. Date: Jun. 25, 2026

(54) DIAPHRAGM TYPE SUBSTRATE PROCESSING DEVICE

(71) Applicant: SCIENTECH CORPORATION, TAIPEI CITY (TW)

(72) Inventors: Min-Ku HSIEH, TAIPEI CITY (TW); Mao-Lin LIU, TAIPEI CITY (TW)

(21) Appl. No.: 19/037,098

(22) Filed: Jan. 25, 2025

(30) Foreign Application Priority Data
Dec. 19, 2024 (TW) 113214010

(51) Int. Cl. B25B 11/00

(52) U.S. Cl. CPC B25B 11/00

(57) ABSTRACT

A diaphragm type substrate processing device for carrying and processing a circular substrate includes a carrying base, a carrier and an isolation structure. The carrying base includes a negative pressure chamber. The carrier includes an outer frame and a diaphragm installed in the outer frame, an outer edge of the diaphragm is fixed to the outer frame, and the diaphragm is stacked on the carrying base to close the negative pressure chamber, the diaphragm includes a working surface configured to be corresponding to the negative pressure chamber and provided with a plurality of through holes penetrating through the diaphragm. The isolation structure is for carrying the circular substrate and protruded from the working space of the diaphragm, so that the circular substrate is spaced apart from the working space of the diaphragm.

### BACKGROUND OF THE DISCLOSURE

### Technical Field

The present disclosure relates to a substrate processing device, particularly relates to a leak-proof diaphragm type substrate processing device.

### Description of Related Art

In general, related-art substrate processing devices have a carrier for carrying a substrate to be processed, and facilitating the placement of the substrate to be placed on a base for processing. Negative pressure attraction is a means of fixing the substrate. The carrier is usually perforated, so that the substrate is attracted to the top of the carrier by simply placing a negative pressure pipeline at the bottom of the carrier to provide negative pressure. However, due to the plane-to-plane contact between the substrate and the carrier, it is difficult to achieve a tight fit, when the substrate is processed on the top of the carrier, the liquid used in the process will easily penetrate into the gap between the substrate and the carrier and further penetrate into the negative pressure pipeline at the bottom of the carrier through the perforations of the carrier, which will corrode the negative pressure pipeline.

In view of the deficiencies of the related art, the present discloser conducted researches based on the existing technologies and the application of theories, and finally developed a diaphragm type substrate processing device in accordance with the present disclosure to overcome the deficiencies of the related art.

### SUMMARY OF THE DISCLOSURE

The present disclosure provides a leak-proof diaphragm type substrate processing device.

The present disclosure provides a diaphragm type substrate processing device for carrying and processing a circular substrate, which includes a carrying base, a carrier and an isolation structure. The carrying base includes a negative pressure chamber. The carrier includes an outer frame and a diaphragm installed in the outer frame, an outer edge of the diaphragm is fixed to the outer frame, the diaphragm is stacked on the carrying base for closing the negative pressure chamber, the diaphragm has a working surface and a plurality of through holes formed on the working surface, configured to be corresponding to the negative pressure chamber, and penetrating through the diaphragm. The isolation structure is provided for carrying the circular substrate, and the isolation structure protrudes from the working surface of the diaphragm, so that the circular substrate is spaced apart from the working surface of the diaphragm.

In an embodiment of the present disclosure, the top of the isolation structure is arranged along a carrying plane, and the carrying plane is spaced apart from the working surface of the diaphragm.

In an embodiment of the present disclosure, the isolation structure includes a plurality of circular ribs integrally formed with the diaphragm and concentrically configured, and the circular ribs protrude from the working surface of the diaphragm and have a top edge which defines the carrying plane.

In an embodiment of the present disclosure, the isolation structure includes a circular rib, and the through holes are arranged within an area enclosed by the circular rib.

In an embodiment of the present disclosure, the circular rib is configured to be corresponding to an edge of the circular substrate.

In an embodiment of the present disclosure, the isolation structure includes a plate stacked on the working surface of the diaphragm, and the carrying plane is defined at the top of the plate.

In an embodiment of the present disclosure, the through holes are arranged within an area enclosed by the periphery of the plate.

In an embodiment of the present disclosure, the plate is provided with a plurality of channels configured to be corresponding to the through holes and penetrating through the plate, and each channel is connected between the carrying plane and the corresponding through hole.

In an embodiment of the present disclosure, the periphery of the plate is disposed in the periphery of the circular substrate, and the periphery of the plate is spaced apart from the periphery of the circular substrate.

When the circular substrate is processed by the diaphragm type substrate processing device, the circular substrate is stacked on the working surface of the diaphragm and carried on the carrying plane defined by the outer shape of the isolation structure, so that the circular substrate is spaced apart from the working surface. When the circular substrate is being processed, the aforementioned structure prevents process liquids from penetrating into the negative pressure chamber through the gap between the circular substrate and the working surface of the diaphragm, which will corrode the pipeline.

### BRIEF DESCRIPTION OF THE DRAWINGS

FIG. 1 is a perspective view of a diaphragm type substrate processing device of the present disclosure.

FIG. 2 is a top view of the diaphragm type substrate processing device of a first embodiment of the present disclosure.

FIG. 3 is a cross-sectional view of the diaphragm type substrate processing device of the first embodiment of the present disclosure.

FIG. 4 is a partially enlarged view of FIG. 3.

FIG. 5 is a perspective view of the diaphragm type substrate processing device of a second embodiment of the present disclosure.

FIG. 6 is a top view of the diaphragm type substrate processing device of the second embodiment of the present disclosure.

FIG. 7 is a cross-sectional view of the diaphragm type substrate processing device of the second embodiment of the present disclosure.

FIG. 8 is a partially enlarged view of FIG. 7.

### DETAILED DESCRIPTION

The detailed description and technical contents of the present disclosure are illustrated with reference to the accompanying drawings, which are intended for the illustrative purposes only, but not intended for limiting the disclosure.

In the description of this disclosure, it should be understood that the terms “front”, “back”, “left”, “right”, “front end”, “back end”, “end”, “vertical”, “horizontal”, “perpendicular”, “Top”, “bottom” etc. refer to an indicated orientation and a positional relation based on the orientation and positional relation as shown in the attached drawings. These terms are used for the purpose of describing the creation of this disclosure and simplifying the description, but not intended for indicating or implying that the device or component must have the specific position, the specific positional structure and operation, so that these terms should not be construed as a limitation on this disclosure.

As used herein and not otherwise defined, the terms “substantially” and “approximately” are used to describe and recount small changes. When combined with an event or situation, the term may encompass the precise moment of occurrence of the event or situation, and the occurrence of the event or situation to a close approximation. For example, when combined with a numerical value, the term may include a range of variation that is less than or equal to ±10% of the value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

The technical contents of this disclosure will become apparent with the detailed description of embodiments accompanied with the illustration of related drawings as follows. It is intended that the embodiments and drawings disclosed herein are to be considered illustrative rather than restrictive.

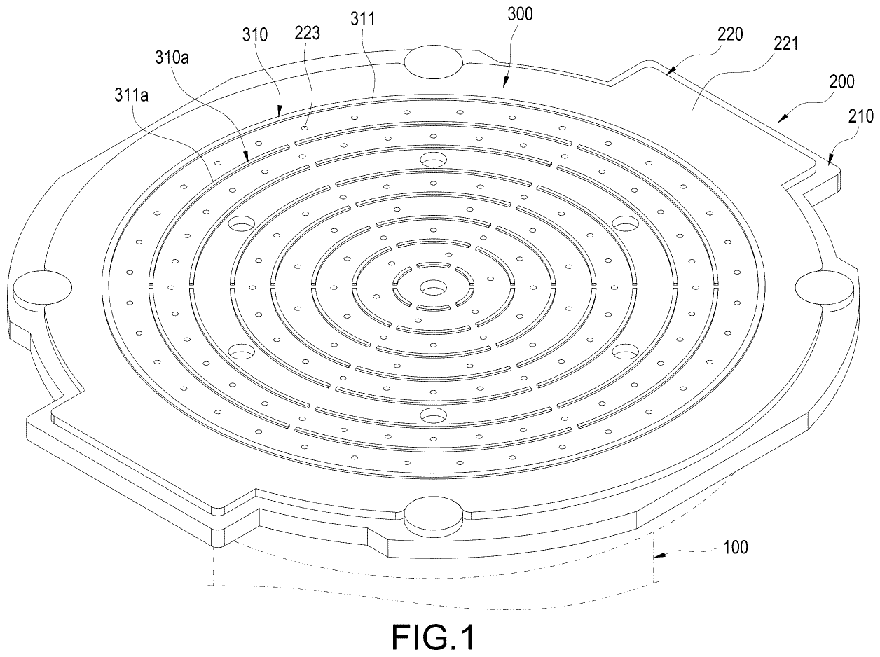

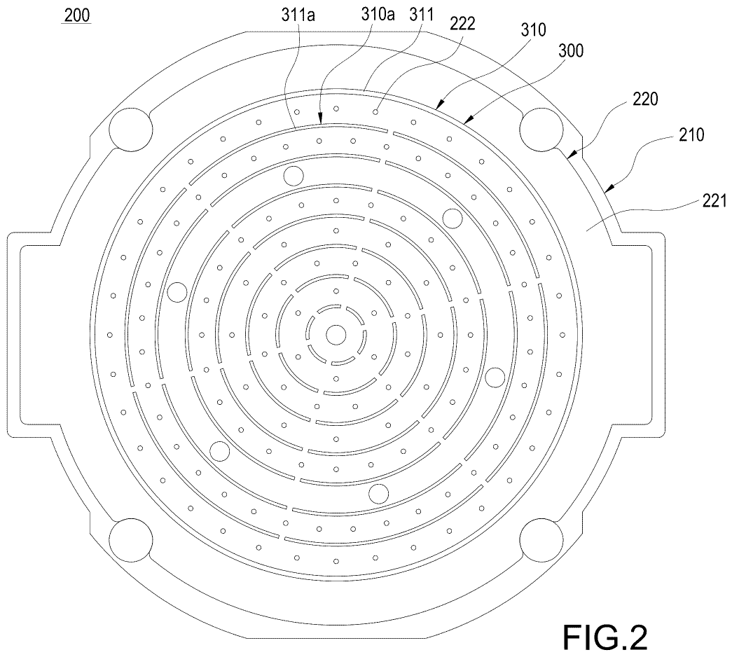

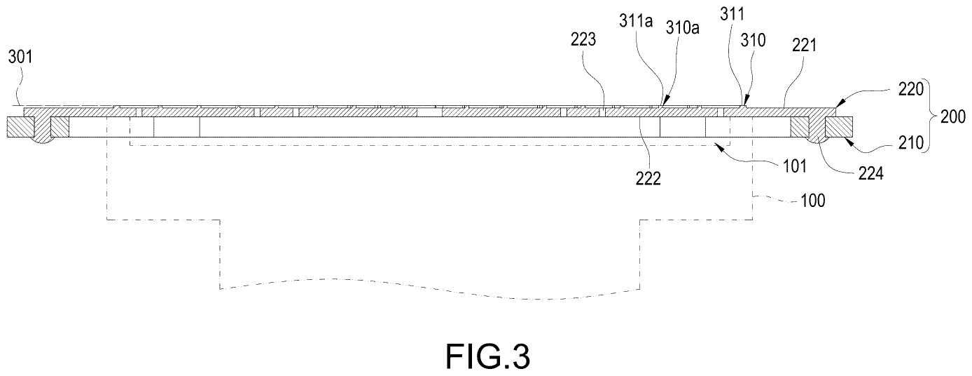

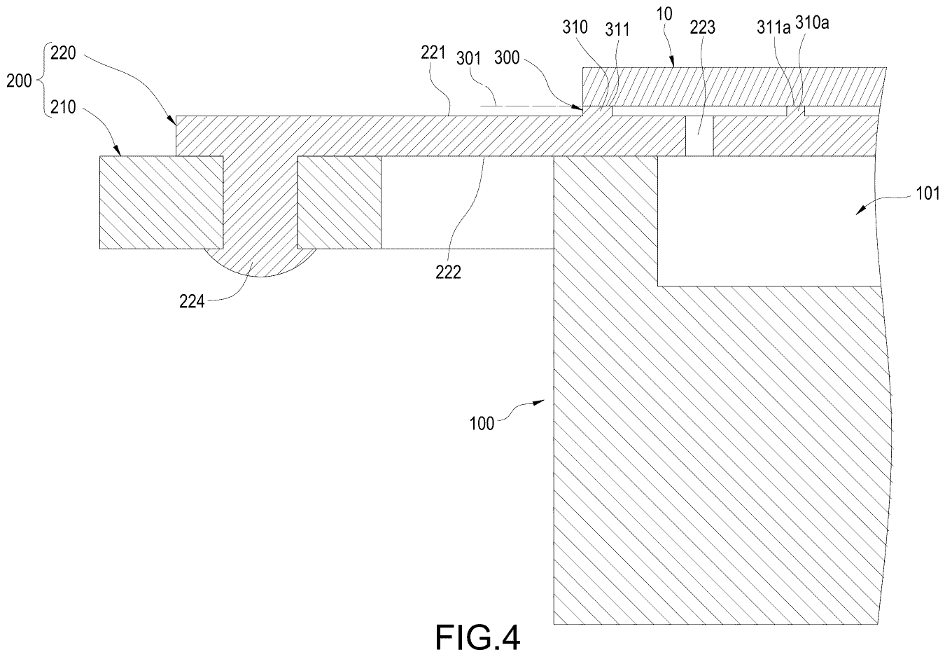

FIG. 1 is the perspective view of the diaphragm type substrate processing device of the first embodiment of the present disclosure. FIG. 2 is the top view of the diaphragm type substrate processing device of the first embodiment of the present disclosure. FIG. 3 is the cross-sectional view of the diaphragm type substrate processing device of the first embodiment of the present disclosure. FIG. 4 is the partially enlarged view of FIG. 3.

In FIGS. 1 to 4, the first embodiment of the present disclosure provides a diaphragm type substrate processing device for carrying and processing a circular substrate 10, and it includes a carrying base 100, a carrier 200 and an isolation structure 300.

The carrying base 100 is substantially in the shape of a vertical column and rotatable along its central axis, the carrying base 100 has a negative pressure chamber 101 located at the top of the carrying base 100, the top of the negative pressure chamber 101 is in an open form at the top of the carrying base 100, and the negative pressure chamber 101 is connected to a negative pressure source through a pipeline.

The carrier 200 is located at the top of the carrying base 100 for carrying the circular substrate 10 to facilitate putting the circular substrate 10 on the carrying base 100. In this embodiment, the carrier 200 includes an outer frame 210 and a diaphragm 220 installed in the outer frame 210, and an outer edge of the diaphragm 220 is fixed to the outer frame 210. In some embodiments, the diaphragm 220 has a working surface 221 and a back surface 222 on the opposite side of the working surface 221, the back surface 222 at the outer edge of the diaphragm 220 is convexly provided with a fastener 224, and the diaphragm 220 is fastened to the outer frame 210 by the fastener 224 and fixed to the outer frame 210. The diaphragm 220 is stacked on the top of the carrying base 100, the negative pressure chamber 101 is closed by the back surface 222 of the diaphragm 220, the diaphragm 220 has a plurality of through holes 223 formed on the working surface 221, configured to be corresponding to the negative pressure chamber 101, and penetrating through the diaphragm 220, and each through hole 223 communicates to the negative pressure chamber 101.

The isolation structure 300 is provided for carrying the circular substrate 10, and protrudes from the working surface 221 of the diaphragm 220, so that the circular substrate 10 is spaced apart from the working surface 221 of the diaphragm 22. In this embodiment, the top of the isolation structure 300 is arranged along a carrying plane 301, and the carrying plane 301 is spaced apart from the working surface 221 of the diaphragm 220. In some embodiments, the isolation structure 300 includes a circular rib 310 integrally formed (or formed in a one piece) with the diaphragm 220 and protruding from the working surface 221 of the diaphragm 220, the circular rib 310 has a top edge 311 which defines a carrying plane 301, and the circular rib 310 is configured to be corresponding to an edge of the circular substrate 10. In this embodiment, the through holes 223 are arranged within an area enclosed by the circular rib 310.

In this embodiment, the isolation structure 300 further includes a plurality of support ribs 310a integrally formed (or formed in a one piece) with the diaphragm 220 and protruding from the working surface 221 of the diaphragm 220, and the support ribs 310a are arranged within an area enclosed by the circular rib 310. Each support rib 310a has a top edge 311a, and the top edges 311a of the support ribs 310a are configured to be coplanar with the carrying plane 301. In some embodiments, the support rib 310a are concentrically arranged circles or arcs with respect to the circular rib 310.

When the circular substrate 10 is processed by the diaphragm type substrate processing device of this embodiment, the circular substrate 10 is stacked on the working surface 221 of the diaphragm 220, and carried by the carrying plane 301 defined by the outer shape of the isolation structure 300, so that the circular substrate 10 is spaced apart from the working surface 221. A side of an edge of the circular substrate 10 is stacked on the top edge 311 of the circular rib 310. The negative pressure source creates a negative pressure in the negative pressure chamber 101, so that the circular substrate 10 is driven by the negative pressure attraction of each through hole 22 to move towards the working surface 2213, so as to compress the circular rib 310 to tight fit the circular substrate 10 with the diaphragm 220. The support rib 310a supports the circular substrate 10 to prevent the circular substrate 10 from being bent by the negative pressure. When another surface of the circular substrate 10 is processed, the aforementioned structure prevents process liquids from penetrating through the gap between the circular substrate 10 and the diaphragm 220 into the negative pressure chamber 101, which may corrode the pipeline.

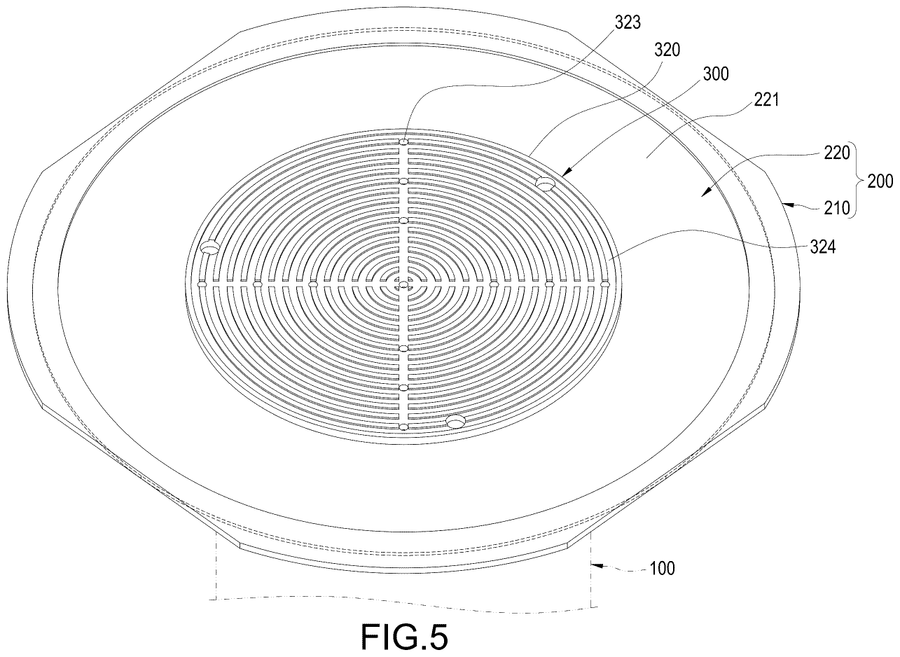

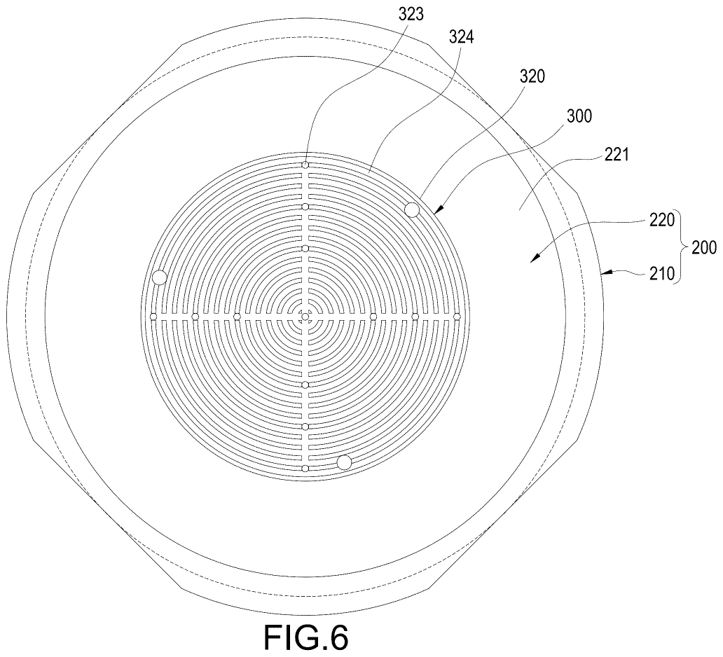

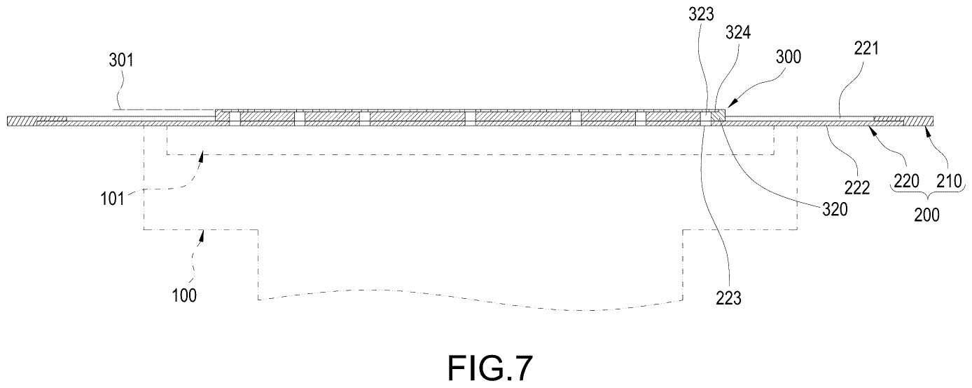

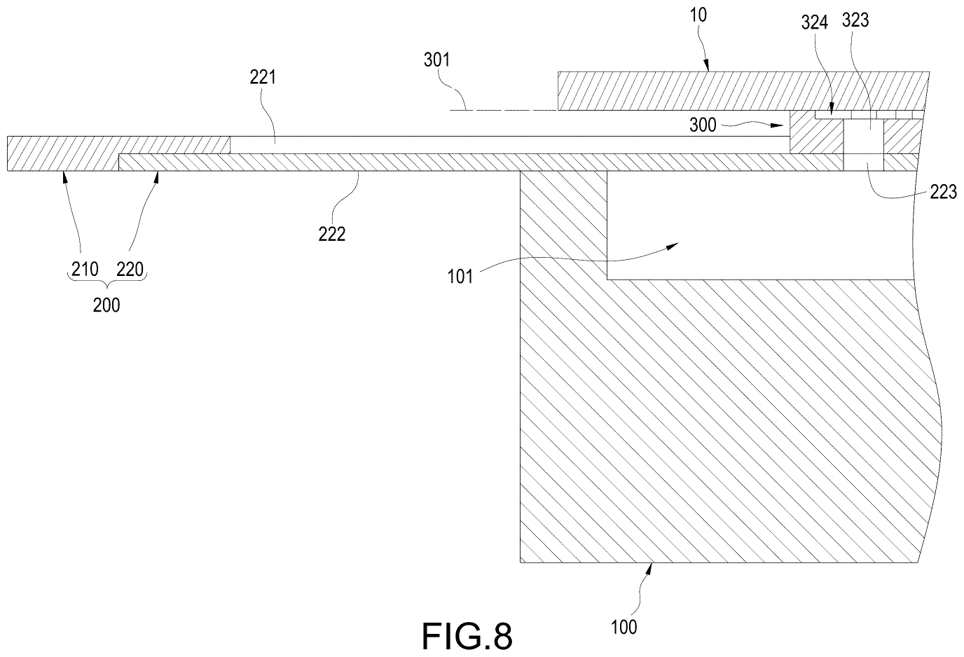

FIG. 5 is a perspective view of the diaphragm type substrate processing device of the second embodiment of the present disclosure. FIG. 6 is a top view of the diaphragm type substrate processing device of the second embodiment of the present disclosure. FIG. 7 is the cross-sectional view of the diaphragm type substrate processing device of the second embodiment of the present disclosure. FIG. 8 is a partially enlarged view of FIG. 7.

In FIGS. 5 to 8, the second embodiment of the present disclosure provides a diaphragm type substrate processing device for carrying and processing a circular substrate 10, and it includes a carrying base 100, a carrier 200 and an isolation structure 300.

The carrying base 100 is substantially in the shape of a vertical column and rotatable along its central axis, the carrying base 100 has a negative pressure chamber 101 located at the top of the carrying base 100, the top of the negative pressure chamber 101 is in an open form at the top of the carrying base 100, and the negative pressure chamber 101 is connected to a negative pressure source through a pipeline.

The carrier 200 is located at the top of the carrying base 100 for carrying the circular substrate 10 to facilitate putting the circular substrate 10 on the carrying base 100. In this embodiment, the carrier 200 includes an outer frame 210 and a diaphragm 220 installed in the outer frame 210, and an outer edge of the diaphragm 220 is fixed to the outer frame 210. In some embodiments, the diaphragm 220 has a working surface 221 and a back surface 222 on the opposite side of the working surface 221, the outer edge of the working surface 221 of the diaphragm 220 is embedded into the outer frame 210 and attached and fixed to the outer frame 210. The diaphragm 220 is stacked on the top of the carrying base 100, and the negative pressure chamber 101 is closed by the back surface 222 of the diaphragm 220, the diaphragm 220 has a plurality of through holes 223 formed on the working surface 221, configured to be corresponding to the negative pressure chamber 101, and penetrating through the diaphragm 220, and each through hole 223 communicates to the negative pressure chamber 101.

The isolation structure 300 is provided for carrying the circular substrate 10 and protruded from the working surface 221 of the diaphragm 220, so that the circular substrate 10 is spaced apart from the working surface 221 of the diaphragm 220. In this embodiment, the top of the solation structure 300 is arranged along a carrying plane 301, and the carrying plane 301 is spaced apart from the working surface 221 of the diaphragm 220. In some embodiments, the isolation structure 300 includes a plate 320 stacked on the working surface 221 of the diaphragm 220, and the carrying plane 301 is defined at the top of the plate 320. The through holes 223 of the diaphragm 220 are arranged within an area enclosed by the periphery of the plate 320. The plate 320 is provided with a plurality of channels 323, each channel 323 penetrates two sides of the plate 320, the channels 323 are configured to be corresponding to the through holes 223 on the diaphragm 220 respectively, and each channel 323 is connected between the carrying plane 301 and the corresponding through hole 223. The top of the plate 320 is further provided with a groove communicating to the channels 323.

In this embodiment, the isolation structure 300 further includes a plurality of support ribs 310a integrally formed (or formed in a one piece) with the diaphragm 220 and protruding from the working surface 221 of the diaphragm 220, and the support ribs 310a are arranged within an area enclosed by the circular rib 310. Each support rib 310a has a top edge 311a, and the top edges 311a of the support ribs 310a are configured to be coplanar with the carrying plane 301. In some embodiments, the support rib 310a is a concentrically arranged circle or arc with respect to the circular rib 310.

When the circular substrate 10 is processed by the diaphragm type substrate processing device of this embodiment, the circular substrate 10 is stacked on the working surface 221 of the diaphragm 220, and the circular substrate 10 is carried on a carrying plane 301 defined by the outer shape of the isolation structure 300, so that the circular substrate 10 is spaced apart from the working surface 221. A side of the circular substrate 10 is stacked on the plate 320 and the periphery of the plate 320 is arranged within an area enclosed by the periphery of the circular substrate 10. The negative pressure source creates a negative pressure in the negative pressure chamber 101, so that the circular substrate 10 is attached onto the plate 320 by the negative pressure attraction of each through hole 223, and the groove at the top of the plate 320 is provided for dispersing the negative pressure in the channels 323 in order to uniformly apply forces of the negative pressure to the circular substrate. When the other side of the circular substrate 10 is processed, the aforementioned structure prevents process liquids from penetrating through the gap between the circular substrate 10 and the plate 320 into the negative pressure chamber 101, which may corrode the pipeline.

While this disclosure has been described by means of specific embodiments, numerous modifications and variations may be made thereto by those skilled in the art without departing from the scope and spirit of this disclosure set forth in the claims.

What is claimed is:

1. A substrate processing device, for carrying and processing a circular substrate, the substrate processing device comprising:
a carrying base, comprising a negative pressure chamber;
a carrier, comprising an outer frame and a diaphragm installed in the outer frame, an outer edge of the diaphragm being fixed to the outer frame, the diaphragm being stacked on the carrying base to close the negative pressure chamber, the diaphragm comprising a working surface and a plurality of through holes defined on the working surface corresponding to the negative pressure chamber and penetrating through the diaphragm; and
an isolation structure, configured to carry the circular substrate, and disposed protrusively on the working surface of the diaphragm to isolate the circular substrate and the working surface of the diaphragm.

2. The substrate processing device according to claim 1, wherein a top of the isolation structure is arranged along a carrying plane, and the carrying plane is spaced apart from the working surface of the diaphragm.

3. The substrate processing device according to claim 2, wherein the isolation structure comprises a circular rib disposed on the diaphragm in an integral form, and the circular rib is disposed protrusively on the working surface of the diaphragm and comprises a top edge which defines the carrying plane.

4. The substrate processing device according to claim 3, wherein the isolation structure comprises a plurality of support ribs disposed on the diaphragm in an integral form, the support ribs disposed protrusively on the working surface of the diaphragm, each support rib comprises a top edge, and a plurality of top edges of the support ribs is coplanar with the carrying plane.

5. The substrate processing device according to claim 4, wherein the support ribs are arranged within an area enclosed by the circular rib.

6. The substrate processing device according to claim 3, wherein the through holes are arranged within an area enclosed by the circular rib.

7. The substrate processing device according to claim 6, wherein the circular rib is disposed corresponding to an edge of the circular substrate.

8. The substrate processing device according to claim 2, wherein the isolation structure comprises a plate stacked on the working surface of the diaphragm, and the carrying plane is defined at a top of the plate.

9. The substrate processing device according to claim 8, wherein the through holes are arranged within an area enclosed by periphery of the plate.

10. The substrate processing device according to claim 8, wherein the plate comprises a plurality of channels defined corresponding to the through holes and penetrating through the plate, and each channel is connected between the carrying plane and one of the through holes correspondingly.

11. The substrate processing device according to claim 8, wherein periphery of the plate is disposed inside periphery of the circular substrate, and periphery of the plate is spaced apart from periphery of the circular substrate.
